(19) United States
(12) Patent Application Publication
(10) Pub. No.: US 2026/0071703 A1
(43) Pub. Date: Mar. 12, 2026

(54) Quick connector and water pump with shower assembly

(71) Applicant: Jinyu Yang, Guangyuan (CN)

(72) Inventor: Jinyu Yang, Guangyuan (CN)

(21) Appl. No.: 18/913,203

(22) Filed: Oct. 11, 2024

(30) Foreign Application Priority Data
Sep. 11, 2024 (CN) 2024222272318

(51) Int. Cl. F16L 37/091; F16L 37/098

(52) U.S. Cl. CPC F16L 37/091; F16L 37/0985

(57) ABSTRACT

This application relates to the technical field of connection structures, and in particular to a quick connector, which is characterized in that it comprises a connector, that serves as an installation body and is used to connect and communicate multiple pipes to ensure that liquid flows inside the connector; a quick-connect assembly is arranged at at least one end of the connector; wherein the quick-connect assembly comprises a spring assembly and a pressing ring which are placed in sequence from the inside to the outside of the connector; the spring assembly is used to clamp a water pipe to be connected, and the spring assembly comprises a spring sheet, which extends toward the axis of the pressing ring and extends out of the inner ring of the pressing ring; the pressing ring is suitable for moving along the axis direction of the connector to push the spring sheet to extend and retract.

### FILD OF THE APPLICATION

This application relates to the technical field of fire fighting equipment, and specifically to a quick connector and water pump with shower assembly.

### BACKGROUD

Most of the joints available on the market are installed using threads, or the pipes are directly inserted into the water outlet for installation. Usually, the threads need to be screwed in more than 5-10 times before they can be installed, which is not very convenient. The same is true for disassembly, which requires many turns of the knob to disassemble. At the same time, for joints directly installed on the water outlet, if the installation is easy, they will easily fall off when the hot and cold water alternate, resulting in unreliability. If the installation is too tight, it won't be easy to disassemble and cannot be used again.

### SUMMARY

To address the inconvenience of connecting existing threaded joints, this application introduces a quick connector and water pump with shower assembly.

The technical solution of this application is:

A quick connector, characterized in that it comprises: a connector; a quick-connect assembly, which is arranged at at least one end of the connector; wherein the quick-connect assembly comprises a circlip assembly and a pressing ring which are arranged in sequence from the inner side to the outer side of the connector; wherein the circlip assembly comprises a spring piece, which extends toward the axis of the pressing ring and extends out of the inner ring of the pressing ring; wherein the pressing ring is suitable for moving along the axis direction of the connector to push the spring piece to extend and retract.

Wherein the spring piece has a first inclined surface extending away from one end of the pressing ring, and a second inclined surface is provided at one end of the pressing ring facing the spring piece.

Wherein a plurality of the first inclined surfaces form a conical surface; one end of the pressing ring facing the first inclined surface is provided as a cone sleeve, and the cone sleeve has the second inclined surface.

Wherein the large end of the cone sleeve is formed with a first hook surface; wherein the inner wall of the connector or the inner wall of the fixing portion of the circlip assembly is provided with a second hook surface; the second hook surface is suitable for abutting against the first hook surface (2211) to limit the position along the axial direction of the connector.

Wherein the circlip assembly further comprises a spring piece and a ferrule; wherein the ferrule is installed in the connector; wherein the spring piece is clamped on the ferrule; wherein a plurality of the spring piece are evenly distributed in an annular shape on the spring piece.

Wherein the spring ring and the spring piece are made of metal and/or the ferrule is made of metal.

Wherein the quick-connect assembly further comprises a sealing ring; the sealing ring is arranged on a side of the retaining circlip assembly away from the pressing ring.

Wherein the pressing ring further comprises an annular flange, and a gap is provided between the annular flange and the connector.

Wherein a quick connector and a pump, comprising both ends of the quick connector are provided with the quick-connect assembly; a mounting groove is provided in the water pump body for mounting the quick connector; a first end of the quick connector is connected to a water pump pipe of the water pump body; a second end of the quick connector extends out of the water pump body and is used to connect to a water pipe to be used.

A shower assembly, characterized in that: it comprises a water pump and a shower head, wherein the water pump has a built-in power supply; and the second end of the quick connector of the water pump is connected to the water inlet pipe of the shower head.

The present application offers several advantages over prior art.

The quick connector in this application comprises a connector; at least one end of the connector is provided with a quick-connect assembly; wherein the quick-connect assembly comprises a spring assembly and a pressing ring which are sequentially arranged from the inside to the outside of the connector (which can be understood as from the inside of the tube to the outside of the tube); the spring assembly comprises a spring sheet, which extends toward the axis of the pressing ring and extends out of the inner ring of the pressing ring; the pressing ring is suitable for moving along the axis direction of the connector to push the spring sheet to expand and contract; the connector serves as an installation body and is used to connect and communicate multiple pipes to ensure that liquid flows inside the connector; at least one end of the connector is provided with a quick-connect assembly, which is used for fast installation and fast removal of pipes; the spring assembly is used for clamping the water pipe to be connected; the pressing ring can be used to unlock the clamping state of the spring assembly on the water pipe; When it is necessary to connect the water pipe, the pressing ring does not push the spring sheet, and the spring sheet is in an extended state at this time, so that the water pipe passes through the pressing ring and the circlip assembly; the spring sheet in the circlip assembly is compressed by the water pipe to produce displacement, and because the spring sheet is elastic, it will clamp the water pipe under its own restoring force, thereby realizing the quick connection of the water pipe and the embodiment of the present application; when it is necessary to pull out the water pipe from the connecting body, the pressing ring is pressed to make it push the spring sheet and compress it again, thereby separating the spring sheet from the water pipe, that is, releasing the clamping state of the spring sheet on the water pipe, and the water pipe can be pulled out freely at this time, thereby realizing the quick disassembly of the water pipe; in this way, the simple structure of the embodiment of the present application can realize stable connection and quick plugging and unplugging of the water pipe, with low manufacturing cost, simple operation and high practicality, and is suitable for popularization and use.

### BRIEF DESCRIPTION OF THE DRAWINGS

The technology may be more completely understood in connection with the following drawings, in which:

FIG. 1 is a perspective view, according to embodiment 1;

FIG. 2 is a front view, according to embodiment 1;

FIG. 3 is a sectional view of A-A from FIG. 2, according to an embodiment;

FIG. 4 is an enlarged view of B from FIG. 3, according to an embodiment;

FIG. 5 is a perspective view, according to embodiment 2.

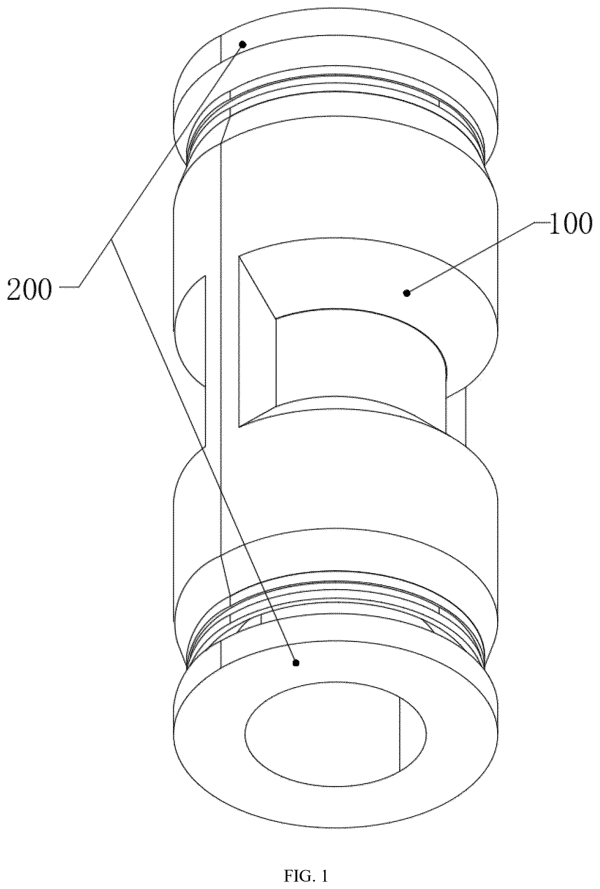

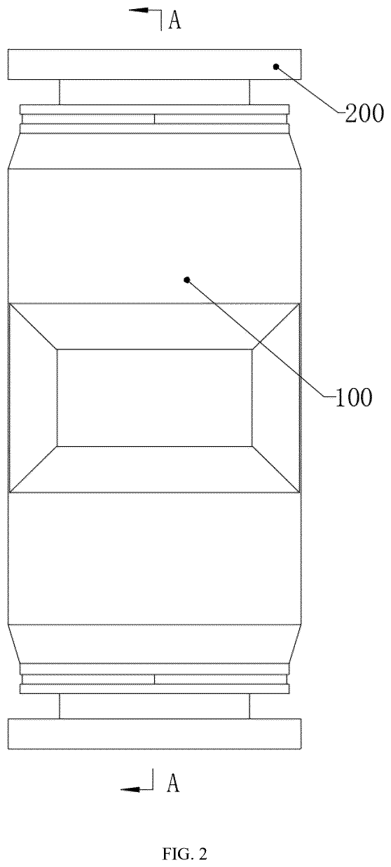

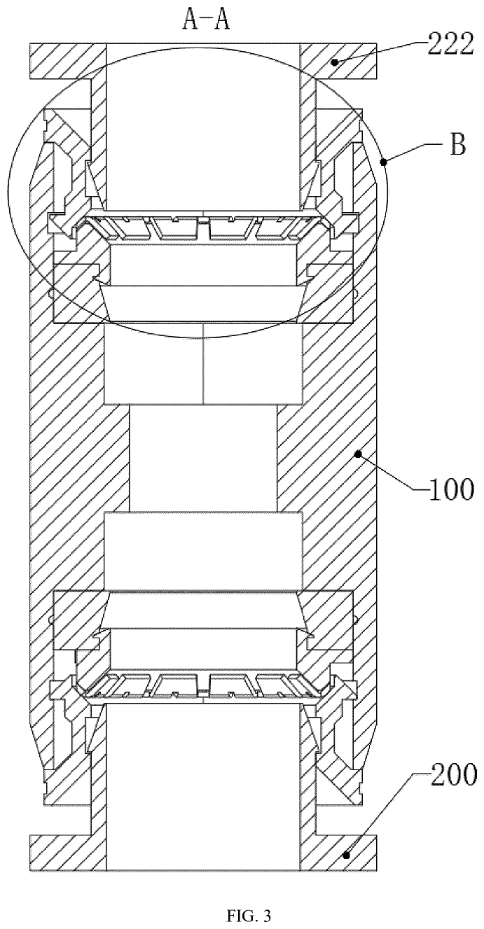

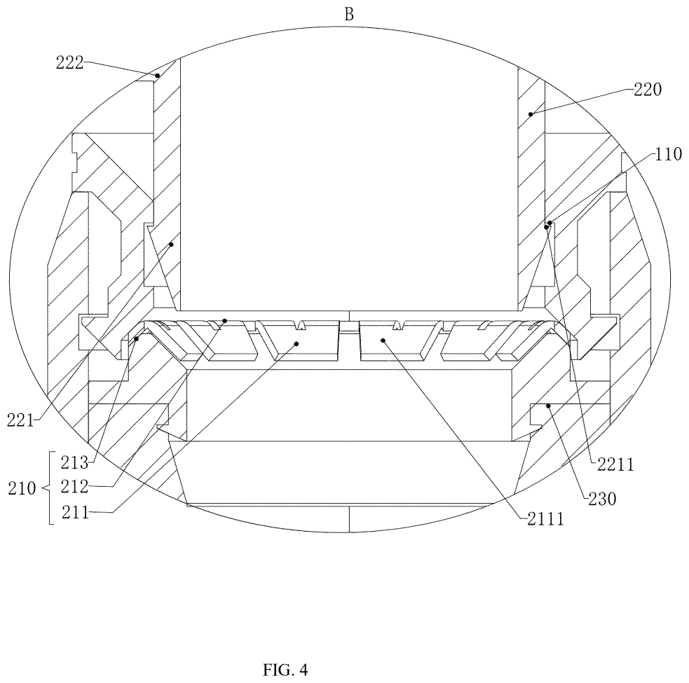

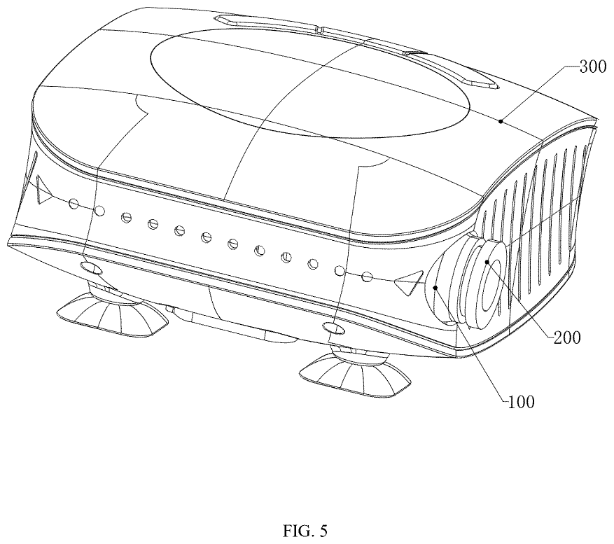

As show in FIGS. 1-5:
100. connector
200. quick-connect assembly
300. water pump body
110. second hook surface
210. Circlip assembly
211. spring piece
2111. first inclined surface
212. spring ring
213. ferrule
220. pressing ring
221. cone sleeve
2211. first hook surface
222. annular flange
223. sealing ring

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION OF EMBODIMENTS

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

For the sake of simplicity, the text may use terms that describe the relative position or movement of one element or feature to another, as shown in the figure. These terms may include “inside,” “outside,” “inner side,” “outer side,” “below,” “above,” “front,” “back,” and so on. These terms are meant to encompass different orientations of the device in use, other than the orientation depicted in the figure. For example, if the device undergoes a position flip, posture change, or motion state change, then these directional indications will also change accordingly. For instance, an element described as “below” other elements or features may subsequently be oriented as “above” other elements or features. Therefore, the term “below” may include both upper and lower orientations. The device may be otherwise oriented (rotated 90 degrees or in other directions), and the spatial relative descriptors used in the text should be interpreted accordingly.

### Embodiment 1

A quick connector, characterized in that it comprises: a connector 100; a quick-connect assembly 200, which is arranged at at least one end of the connector 100; wherein the quick-connect assembly 200 comprises a circlip assembly 210 and a pressing ring 220 which are arranged in sequence from the inner side to the outer side of the connector 100; wherein the circlip assembly 210 comprises a spring piece 211, which extends toward the axis of the pressing ring 220 and extends out of the inner ring of the pressing ring 200; wherein the pressing ring 220 is suitable for moving along the axis direction of the connector 100 to push the spring piece 211 to extend and retract.

In this embodiment, the connector 100 serves as an installation body and is used to connect and communicate multiple pipes to ensure that liquid flows inside the connector; at least one end of the connector 100 is provided with a quick-connect assembly 200, and the quick-connect assembly 200 is used for quick installation and quick removal of pipes; it should be understood that at least one end can be one end, two ends, three ends or even more; for example, when the connector 100 is a single tube, the connector 100 has two ends, and at this time, one end or both ends of the connector 100 can be provided with a quick-connect assembly 200 for accessing the pipe; when the connector 1 When 00 is a three-way pipe, one end, two ends or three ends of the connector 100 can be provided with a quick-connect assembly 200 according to actual needs for connecting the pipe to be used; and so on, there is no restriction on the number of ends of the connector 100 and the number of corresponding quick-connect assemblies 200; further, the quick-connect assembly 200 includes a circlip assembly 210 and a pressing ring 220 which are sequentially arranged from the inside to the outside of the connector 100 (which can be understood as from the inside of the pipe to the outside of the pipe); the circlip assembly 210 is used to clamp the water pipe to be connected; the pressing ring 220 can be used to unlock the circlip assembly 210 is used to clamp the water pipe; specifically, the circlip assembly 210 includes a spring piece 211, which extends toward the axis of the pressing ring 220 and extends out of the inner ring of the pressing ring 200. The spring piece 211 is arranged to extend out of the inner ring of the pressing ring 200 to clamp the water pipe to be connected through the spring piece 211, and the spring piece 211 will not be blocked by the pressing ring 200, resulting in the spring piece 211 being unable to clamp the water pipe to be connected; further, the pressing ring 220 is suitable for moving along the axial direction of the connector 100 to push the spring piece 211 to retract; for ease of understanding, an example is given as follows: when the water pipe needs to be connected, the pressing ring 220 does not push the spring piece 211, and the spring piece 211 is in an extended state at this time, and the water pipe is passed through the pressing ring 220 and the circlip assembly 210; the spring piece 211 in the circlip assembly 210 is compressed by the water pipe to produce displacement. Since spring piece 211 is elastic, the spring piece 211 will clamp the water pipe under its own restoring force, thereby realizing the quick connection of the water pipe and the embodiment of the present application; when the water pipe needs to be pulled out from the connecting body 100, the pressing ring 220 is pressed to push the spring piece 211 to compress it again, thereby separating the spring piece 211 from the water pipe, that is, releasing the clamping state of the spring piece 211 on the water pipe. At this time, the water pipe can be pulled out freely, thereby realizing the quick disassembly of the water pipe; in this way, the simple structure of the embodiment of the present application can realize the stable connection and quick plugging and unplugging of the water pipe, with low manufacturing cost, simple operation, and high practicality, and is suitable for popularization and use.

In an embodiment, the spring piece 211 has a first inclined surface, 2111, extending away from one end of the pressing ring 220. The pressing ring 220 is provided with a second inclined surface at one end of the spring piece 211 to push the spring piece 211 to extend and retract.

In this embodiment, a first inclined surface 2111 is provided on the spring piece 211 (it can also be understood that the spring piece 211 is in an inclined state as a whole), and a second inclined surface is provided on the pressing ring 220. When it is necessary to pull out the water pipe for use, for example, the pressing ring 220 is pushed to drive the second inclined surface to push the first inclined surface 2111 so that the spring piece 211 contracts, making the entire pushing process more labor-saving and smooth. In addition, setting the spring piece 211 in an inclined state is more conducive to the resetting of the spring piece 211 itself after contraction, which can extend the service life of the spring piece 211 and prevent it from being damaged.

In an optional embodiment, a plurality of first inclined surfaces 2111 form a conical surface; one end of the pressing ring 220 facing the first inclined surface 2111 is provided as a cone sleeve 221, and the cone sleeve 221 has a second inclined surface.

In this embodiment, multiple first inclined surfaces 2111 form a conical surface, that is, the spring piece 211 is arranged in multiple and annular distribution, so that the multiple first inclined surfaces 2111 together form a conical surface, and the end of the pressing ring 220 facing the first inclined surface 2111 is arranged as a cone sleeve 221, and the outer surface of the cone sleeve 221 is also conical; through the cooperation of the two conical surfaces, the action of the pressing ring 220 pushing the circlip assembly 210 is more stable.

In an optional embodiment, the circlip assembly 210 also includes a spring ring 212 and a ferrule 213; the ferrule 213 is installed in the connector 100; the spring ring 212 is clamped on the ferrule 213; and a plurality of spring pieces 211 are evenly distributed on the spring ring 212. In this embodiment, the ferrule 213 is installed in the connector 100 to clamp the spring ring 212; in order to prevent the ferrule 213 from moving during use and causing an unstable connection with the water pipe, a limiting structure may be provided in the connector 100 to at least limit the displacement of the ferrule 213 along the axial direction of the connector 100, and can also selectively limit the radial movement or rotation of the ferrule 213 along the connector 100; the arrangement of the spring ring 212 allows the spring piece 211 to be distributed in an annular manner along the spring ring 212, which is beneficial for the circlip assembly 210 to be uniformly stressed when being pushed, and the annular spring ring 212 is suitable for most pipe body shapes; preferably, the spring ring 212 and the spring piece 211 are configured to be metal materials and/or the ferrule 213 is configured to be metal materials, which can effectively improve their service life and stability in use; further, the metal material can be stainless steel, zinc alloy, titanium alloy, or other metal materials that have at least certain anti-rust properties.

In an optional embodiment, a first hook surface 2211 is formed at the large end of the cone sleeve 221; the inner wall of the connector 100 or the inner wall of the fixed part of the circlip assembly 210 (the inner wall of the fixed part here can be the inner wall of the ferrule 213 as described above) has a second hook surface 110; the second hook surface 110 is suitable for abutting and limiting the first hook surface 2211 along the axial direction of the connector 100.

In this embodiment, a first hook surface 2211 is formed by the large end of the cone sleeve 221 itself, and there is no need to design an additional hook surface structure. It is only necessary to allow the large end of the cone sleeve 221 to extend beyond the main body of the pressing ring 220 by a certain length, so that the overall structure of the pressing ring 220 is relatively simple and compact; and a second hook surface 110 is provided on the inner wall of the connector 100 or the inner wall of the fixed part of the retaining spring assembly 200 (the inner wall of the fixed part here can be the inner wall of the ferrule 213 as mentioned above). As for whether the second hook surface 110 is specifically set on the inner wall of the connector 100 or the inner wall of the ferrule 213, it can be set according to specific circumstances; when in use, the pressing ring 220 moves along the axial direction of the connector 100, and moves toward the inner side of the connector 100 to push and compress the spring piece 211; and moves toward the outside to release the compression of the spring piece 211; to prevent the pressing ring from 220 directly escapes from the connector 100, so that the second hook surface 110 can block the first hook surface 2211 when the pressing ring 220 moves outward.

In an optional embodiment, the pressing ring 220 further includes an annular flange 222, which is located at one end of the pressing ring 220 away from the retaining circlip assembly 210, and a gap is provided between the annular flange 222 and the connector 100.

In this embodiment, the annular flange 222 is provided to facilitate the pulling and pushing of the pressing ring 220, and a gap is ensured between the annular flange 222 and the connector 100 to match the moving stroke of the pressing ring 220 and avoid interference.

In an optional embodiment, the quick-connect assembly 200 also includes a sealing ring 230; the sealing ring 230 is arranged on the side of the circlip assembly 210 away from the pressing ring 220; through the setting of the sealing ring 230, the connection between the ferrule 213 in the circlip assembly 210 and the connector 100 can be sealed to ensure the orderly flow of liquid in the pipeline.

### Embodiment 2

The water pump comprises a quick connector and a water pump body 300. Both ends of the quick connector are provided with quick-connect assemblies 200. An installation groove is provided in the water pump body 300 for installing the quick connector. The first end of the quick connector is connected to the water pump pipe of the water pump body 300; the second end of the quick connector extends out of the water pump body 300 and is used to connect the water pipe to be used.

In this embodiment, the quick connector is arranged in the installation groove in the water pump body 300, and the quick connector is used to realize the quick connection between the water pump body 300 and the water parts to be used; when not in use, the water pump body 300 can be quickly disassembled from the water parts to be used, so that this type of water pump is easy to quickly disassemble and assemble with the water pipes to be used; the water pump includes the above-mentioned quick connector, so it should include all the implementation methods and corresponding effects of the above-mentioned quick connector, which will not be repeated here.

### Embodiment 3

The shower assembly comprises a water pump and a shower head. The water pump has a built-in power supply, and the second end of the quick connector of the water pump is connected to the water inlet pipe of the shower head.

In this embodiment, the water pump with a built-in power supply is connected to the shower head using a quick connector. This allows for easy and quick connection and disconnection between the two. For instance, when the unit needs to be moved for use, the two components can be swiftly separated for portability. When using the shower outdoors or in other locations, the water pump and the shower head can be easily connected using the quick connector, making the process simple and convenient. This shower assembly includes the aforementioned shower head, so it encompasses all the implementation methods and corresponding technical effects of the shower head, which will not be reiterated here.

In an optional embodiment, the power source is a rechargeable power source, which is more convenient for outdoor use and repeated use.

The terms used in this document are for describing specific example embodiments and are not intended to be limiting. Unless the context clearly indicates otherwise, the singular forms “one,” “an,” and “said” may also include plural forms. The terms “include,” “comprise,” “contain,” and “have” are inclusive and specify the presence of stated features, steps, operations, elements, and/or parts, but do not exclude the presence or addition of one or more other features, steps, operations, elements, parts, and/or combinations thereof. The method steps, processes, and operations described herein are not necessarily required to be performed in the specific order described or illustrated, unless the execution order is clearly indicated. Additionally, additional or alternative steps may be used.

The terms “first,” “second,” “third,” etc. can be used to describe multiple elements, components, regions, layers, and/or sections in the text. However, it's important to note that these terms should not limit the elements, components, regions, layers, and/or sections. Instead, they are used to distinguish one from another. It's also crucial to understand that when these numerical terms are used, they do not imply a specific order or sequence unless the context clearly indicates otherwise. Therefore, the first element, component, region, layer, or section discussed can be referred to as the second element, component, region, layer, or section without deviating from the intended meaning.

1. A quick connector, characterized in that it comprises: a connector; a quick-connect assembly, which is arranged at at least one end of the connector; wherein the quick-connect assembly comprises a circlip assembly and a pressing ring which are arranged in sequence from the inner side to the outer side of the connector; wherein the circlip assembly comprises a spring piece, which extends toward the axis of the pressing ring and extends out of the inner ring of the pressing ring; wherein the pressing ring is suitable for moving along the axis direction of the connector to push the spring piece to extend and retract.

2. The quick connector of claim 1, wherein the spring piece has a first inclined surface extending away from one end of the pressing ring, and a second inclined surface is provided at one end of the pressing ring facing the spring piece.

3. The quick connector of claim 2, wherein a plurality of the first inclined surfaces form a conical surface; one end of the pressing ring facing the first inclined surface is provided as a cone sleeve, and the cone sleeve has the second inclined surface.

4. The quick connector of claim 3, wherein the large end of the cone sleeve is formed with a first hook surface; wherein the inner wall of the connector or the inner wall of the fixing portion of the circlip assembly is provided with a second hook surface; the second hook surface is suitable for abutting against the first hook surface to limit the position along the axial direction of the connector.

5. The quick connector of claims 1-4, wherein the circlip assembly further comprises a spring piece and a ferrule; wherein the ferrule is installed in the connector; wherein the spring piece is clamped on the ferrule; wherein a plurality of the spring piece are evenly distributed in an annular shape on the spring piece.

6. The quick connector of claim 5, wherein the spring ring and the spring piece are made of metal and/or the ferrule is made of metal.

7. The quick connector of claims 1-4, wherein the quick-connect assembly further comprises a sealing ring; the sealing ring is arranged on a side of the retaining circlip assembly away from the pressing ring.

8. The quick connector of claims 1-4, wherein the pressing ring further comprises an annular flange, and a gap is provided between the annular flange and the connector.

9. A water pump, characterized in that it comprises: a quick connector and a pump as claimed in claims of 1-8, both ends of the quick connector are provided with the quick-connect assembly; a mounting groove is provided in the water pump body for mounting the quick connector; a first end of the quick connector is connected to a water pump pipe of the water pump body;
a second end of the quick connector extends out of the water pump body and is used to connect to a water pipe to be used.

10. A shower assembly, characterized in that: it comprises a water pump and a shower head as claimed in claim 9, wherein the water pump has a built-in power supply; and the second end of the quick connector of the water pump is connected to the water inlet pipe of the shower head.
